(19) United States
(12) Patent Application Publication
(10) Pub. No.: US 2006/0020477 A1
(43) Pub. Date: Jan. 26, 2006

(54) VEHICLE SALES AND SERVICE DATA INTEGRATION SYSTEM AND METHOD

(75) Inventors: Joe Retzbach, Novi, MI (US); John Graham, Plymouth, MI (US); Dennis Doyle, Northville, MI (US); Kevin Berch, Royal Oak, MI (US); Barry Levey, West Bloomfield, MI (US); Ken McCaffrey, Canton, MI (US)

Correspondence Address: BROOKS KUSHMAN P.C./FGTL, 1000 TOWN CENTER, 22ND FLOOR, SOUTHFIELD, MI, 48075-1238, US

(73) Assignee: FORD MOTOR COMPANY, Dearborn, MI (US)

(21) Appl. No.: 10/710,626

(22) Filed: Jul. 26, 2004

(51) Int. Cl. G06Q 99/00

(52) U.S. Cl. 705/1

(57) ABSTRACT

A computer-implemented method for integrating data output from a relationship between a customer and a service or product provider. The method includes receiving one or more customer vehicle attributes from two or more computer systems selected from the group consisting of: a service appointment system, a dealer management system, a marketing offer system, an accessory system, a vehicle inspection system, a follow-up system, and a concern resolution system; storing the one or more customer vehicle attributes into a data warehouse; and transmitting the one or more customer vehicle attributes stored in the data warehouse based upon an electronic request. Advantageously, the one or more customer vehicle attributes are integrated across the two or more computer systems to facilitate management of an after vehicle sales delivery relationship between a customer and a service or product provider.

### BACKGROUND OF INVENTION

1. Field of the Invention

One aspect of the present invention generally relates to a vehicle sales data integration system and method, and more specifically, a computer-implemented method and system for integrating data output from a vehicle sales relationship between a customer and a service or product provider.

2. Background Art

Customer relationship management (CRM) systems have been proposed in the arena of automotive vehicle sales. Original equipment manufacturers (OEMs) and dealers commonly utilize these systems to better manage their customer relationships. Typically, these systems are built around a multi-tiered approach for fostering customer relationships at the national level (tier I), the regional level (tier II) and the dealer level (tier III). Tier I is focused on urging the customer to visit an OEM location or dealer location for a purpose, for example, “see your ABC dealership to schedule your vehicle's next maintenance service.” In this example, ABC stands for an OEM name. Tier II is focused on urging the customer to visit an OEM location or dealer location or a specific region for a purpose, for example, “see your XYZ area ABC dealership to schedule your vehicle's next maintenance service.” In this example, XYZ stands for a geographic area. Tier III is focused on urging the customer to visit a specific dealer for a purpose, for example, “see your EFJ dealership to schedule your vehicle's next maintenance service.” In this example, EFJ stands for the specific dealer name.

A patch work of computer-implemented and non-computer-implemented tools and solutions exist for achieving the goal of communicating to customers on the above-identified levels. For example, a mass mailing system can be used to execute CRM activities in tiers I, II, and III. E-mail distribution systems can also be utilized to carry out CRM activities. As another example, OEMs and dealers commonly buy advertising spots on television programs, Internet websites, and/or print media.

Unfortunately, the above-identified systems lack the integration to achieve focused, customer-centric CRM. In other words, OEMs and dealers cannot reach the customer on the vehicle identification number (VIN) level to carry out coordinated CRM objectives. As a result, inefficiencies and customer dissatisfaction may result. For instance, the OEM may use a mass-mailing system to distribute mailers advertising the newest model year of a certain vehicle make. The mass mailer could be mistakenly sent to customers that have already purchased this vehicle because of a lack of data integration between the mass mailing system and other CRM systems. This results in unnecessary advertising and mailing expenses. Moreover, the customer may be aggravated upon receiving a mass-mailing insert that does not pertain to them. As another example, a customer may visit the OEM for an oil change. This information may not be shared in a timely manner with a CRM system that sends out oil change reminders. As a result, the customer could receive an oil change reminder even though the customer just had an oil change performed on their vehicle.

In light of the foregoing, what is needed is a vehicle sales data integration method and system for integrating data output from a customer vehicle relationship. This system is needed to provide a structure for carrying out focused, customer-centric CRM objectives.

### SUMMARY OF INVENTION

One aspect of the present invention is a method and system for providing consistent service reminders and marketing offers to consumers from original equipment manufacturers (OEMs) and/or vehicle dealers. Another aspect of the present invention is an integrated method and system for scheduling appointment for recall, general service, maintenance and/or marketing offer service to consumers from OEMs and/or vehicle dealers.

Yet another aspect of the present invention is a method and system for providing a unique channel of trade between dealers and customer service entities. Reduced costs can be achieved by using the unique channel, relative to less integrated approaches. The unique channel can present a variety of point of sale strategies. Another aspect of the present invention is the ability to leverage service tools that are integrated into the service tool's dealer management system (DMS). Another aspect is the ability to provide consistent parts and services messaging, through e-mail and or post mail. In yet another aspect, the invention can provide one-stop shopping for a parts and service solution.

Further, customer service departments (CSDs) may realize benefits by virtue of practicing the present invention. For example, a CSD can achieve a heightened visibility for parts and service retailing. The CSD can also leverage its investments in parts and services retail toolsets. Vendor costs can be reduced relative to conventional systems through tight integration with vendors and dealer system providers (DSPs).

In addition to the above-identified benefits, certain embodiments may also provide methodology to aid OEMs and dealers in complying with privacy and/or advertising regulations.

It is understood that the above-identified benefits and aspects are each meant to be exemplary of certain embodiments of the present invention and are no way essential to practicing the present invention, as defined by the claims.

According to one embodiment of the present invention, a computer-implemented method for integrating data output from a relationship between a customer and a service or product provider is disclosed. The method includes receiving one or more customer vehicle attributes from two or more computer systems selected from the group consisting of: a service appointment system, a dealer management system, a marketing offer system, an accessory system, a vehicle inspection system, a follow-up system, and a concern resolution system; storing the one or more customer vehicle attributes into a data warehouse; and transmitting the one or more customer vehicle attributes stored in the data warehouse based upon an electronic request. The one or more customer vehicle attributes are integrated across the two or more computer systems to facilitate management of an after vehicle sales delivery relationship between a customer and a service or product provider. Non-limiting examples of customer vehicle attributes include basic core customer data, vehicle data, financial data, service history data, accessory purchase history data, demographic data, attitudinal data, and loyalty data. The method can further include tracking the one or more customer vehicle attributes. The service or product provider can include a dealer and/or an original equipment manufacturer (OEM). The method can further include communicating or broadcasting a portion of the one or more customer vehicle attributes to the customer. The OEM and/or dealer can conduct this step.

In certain implementations of the above-identified embodiment, the method can further include generating a report based on the one or more customer vehicle attributes. At least a portion of the report can be communicated to the customer. The marketing offer computer system can include functionally for providing a plurality of fulfillment options. In certain implementations, the method can further include formatting or packaging at least a portion of the one or more customer vehicle attributes prior to communicating or broadcasting the portion of the one or more customer vehicle attributes to the customer. The data warehouse can include a mainframe or ASP computer system. In certain implementations, the service appointment system is capable of scheduling service, recall, and recommended maintenance appointments and checking the status of an appointment. Further, the marketing offer system can be capable of transmitting service, maintenance offers, or product offers. Moreover, the accessory system can be capable of processing accessory purchases and installations.

Customer vehicle attribute information can be communicated through a telephone and/or Internet (for example, e-mail). The one or more customer vehicle attributes can be used to facilitate marketing of one or more events.

Other data formatting steps can be practiced in accordance with the above-mentioned method, for example, dealerizing, deduplicating, cleaning, merging and purging of the vehicle customer attributes. It is understood that dealerizing is the assignation of a dealership to a customer based on the customer's address information. The method can further include conducting a national change of address analysis on the one or more customer vehicle attributes and/or conducting privacy “do not call” analysis on the one or more customer vehicle attributes.

According to another embodiment of the present invention, a computer-implemented system for integrating data output from a relationship between a customer and a service or product provider is provided. The system includes two or more computer systems selected from the group consisting of: a service appointment system, a dealer management system, a marketing offer system, an accessory system, a vehicle inspection system, a follow-up system, and a concern resolution system, wherein the two or more computer systems are capable of storing and transmitting one or more customer vehicle attributes; a data warehouse coupled to the two or more computer systems for storing the one or more customer vehicle attributes; and a retrieval module coupled to the data warehouse for retrieving the one or more customer vehicle attributes stored in the data warehouse based upon an electronic request. The one or more customer vehicle attributes are integrated across the two or more computer systems to facilitate management of an after vehicle sales relationship between a customer and a service or product provider.

According to yet another embodiment of the present invention, a computer-implemented apparatus for integrating data output from a relationship between a customer and a service or product provider is disclosed. The apparatus includes a means for receiving one or more customer vehicle attributes from two or more computer systems selected from the group consisting of: a service appointment system, a dealer management system, a marketing offer system, an accessory system, a vehicle inspection system, a follow-up system, and a concern resolution system; a means for storing the one or more customer vehicle attributes into a data warehouse; and a means for transmitting the one or more customer vehicle attributes stored in the data warehouse based upon an electronic request. The one or more customer vehicle attributes are integrated across the two or more computer systems to facilitate management of an after vehicle sales relationship between a customer and a service or product provider.

The above and other objects, features, and advantages of the present invention are readily apparent from the following detailed description of the best mode for carrying out the invention when taken in connection with the accompanying drawings.

### BRIEF DESCRIPTION OF DRAWINGS

The features of the present invention which are believed to be novel are set forth with particularity in the appended claims. The present invention, both as to its organization and manner of operation, together with further objects and advantages thereof, may best be understood with reference to the following description, taken in connection with the accompanying drawings which:

FIG. 1 is a block diagram of the system architecture of a system according to one embodiment of the present invention;

FIG. 2 is a block diagram of the system infrastructure of a system according to one embodiment of the present invention;

FIG. 3 is a block diagram of the system infrastructure of a service appointment system according to one embodiment of the present invention;

FIG. 4 is a block diagram of the system infrastructure of dealer management system according to one embodiment of the present invention;

FIG. 5 is a block diagram of the system infrastructure of a marketing offer system according to one embodiment of the present invention;

FIG. 6 is a block diagram of the system infrastructure of an accessory system according to one embodiment of the present invention; and

FIG. 7 depicts a block diagram of the system architecture of a system that integrates a vehicle inspection system, a follow-up system and a concern resolution system into integrated system, according to one embodiment of the present invention.

### DETAILED DESCRIPTION

As required, detailed embodiments of the present invention are disclosed herein. However, it is to be understood that the disclosed embodiments are merely exemplary of the invention that may be embodied in various and alternative forms. Therefore, specific functional details herein are not to be interpreted as limiting, but merely as a representative basis for the claims and/or as a representative basis for teaching one of ordinary skill in the art to variously employ the present invention.

One aspect of the present invention relates to a computer-implemented system for integrating data output from an after vehicle sales delivery relationship between a customer and a service or product provider. It is understood that the after vehicle sales delivery relationship can begin upon the delivery of a vehicle, for example, constructively or physically, to a customer and the relationship can encompass any activity carried out between the OEM or dealer, or any other service or product providing entity and the customer, including, but not limited to, service, maintenance, recall, trade-in, accessories, etc. It is understood that the terms “customer” and “consumer” can be used interchangeably in this document to refer to individuals that enter into a relationship with a service or product provider, for example, an original equipment manufacturer or a dealer, before, during or after delivery of a vehicle to the “customer” or “consumer.”

According to one embodiment of the present invention, the system includes two or more computer systems selected from the group consisting of: a service appointment system, a dealer management system, a marketing offer system, an accessory system, a vehicle inspection system, a follow-up system, and a concern resolution system. The two or more computer systems are capable of storing and transmitting one or more customer vehicle attributes. The system also includes a data warehouse coupled to the two or more computer systems for storing the one or more customer vehicle attributes. The system also includes a retrieval module coupled to the data warehouse for retrieving the one or more customer vehicle attributes stored in the data warehouse based upon an electronic request. The one or more customer vehicle attributes can be integrated across the two or more computer systems to facilitate management of an after vehicle sales delivery relationship between a customer and a service or product provider. It is understood that the vehicle can be an automobile.

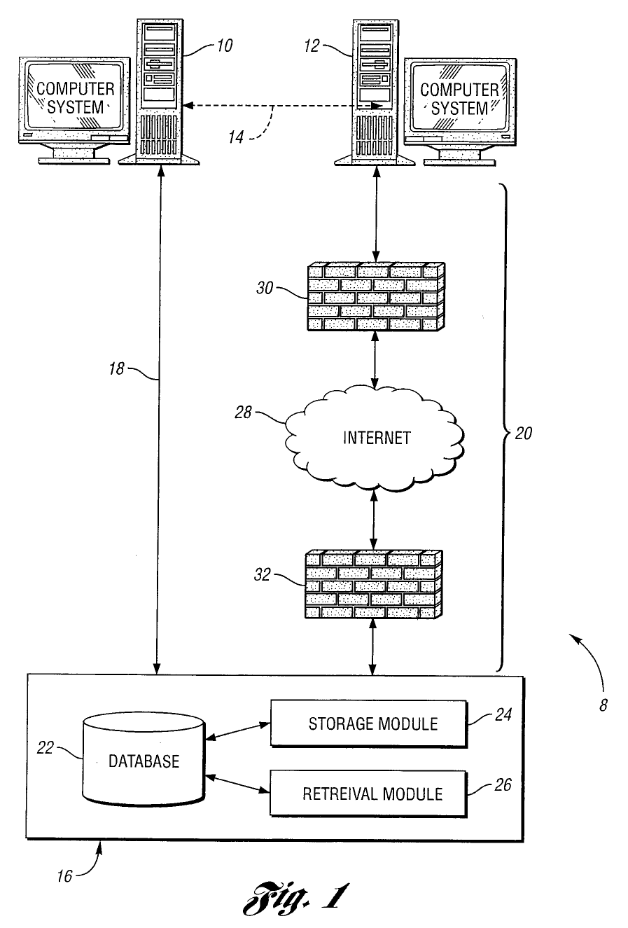

FIG. 1 is a block diagram illustrating overall system 8 for implementing one embodiment of the present invention. Overall system 8 includes computer system 10 and computer system 12, which are optionally interconnected through communication line 14 and are both connected to data warehouse 16 through communication lines 18 and 20. Systems 10 and 12 and data warehouse 16 can be interconnected to a network, for example a local area network (LAN) or a wide area network (WAN), through a variety of interfaces, including, but not limited to dial-in connections, cable modems, high-speed lines, and hybrids thereof.

Computer systems 10 and 12 typically each include one or more server computers for serving users of the system, one or more client computers for interfacing with users of the system, and one or more databases for storage of information used by the system. Non-limiting examples of servers that can be utilized within systems 10 and 12 include database servers, application servers, web servers, directory servers, and mail servers. It will be apparent that the components of systems 10 and 12 depend on the nature of the system.

According to the embodiment depicted in FIG. 1, computer systems 10 and 12 and data warehouse 16 support TCP/IP protocol which has input and access capabilities via two-way communication lines 18 and 20. Another non-limiting example of supportable protocol is voice over Internet protocol, otherwise referred to as VoIP. Data warehouse 16 is a computer system that includes database 22 for storage of information, for example, customer vehicle attributes, storage module 24 for storing information, and retrieval module 26 for retrieving data stored in database 22.

Communication line 18 is an intranet-adaptable communication line, for example, a dedicated line, a satellite link, an Ethernet link, a public telephone network, a private telephone network, and hybrids thereof. Communication line 20 is adaptable to connect to the Internet 28. Examples of suitable communication lines include, but are not limited to, public telephone networks, public cable networks, and hybrids thereof. Firewalls 30 and 32 are provided between data warehouse 16 and Internet 28 and between computer system 12 and Internet 28. A suitable firewall (not shown) may also be provided between data warehouse 16 and computer system 10. It is understood that communication lines 18 and 20 can be purely Internet-adaptable or intranet-adaptable or hybrids thereof. For example, communication line 18 can include an Internet-adaptable portion and an intranet-adaptable portion.

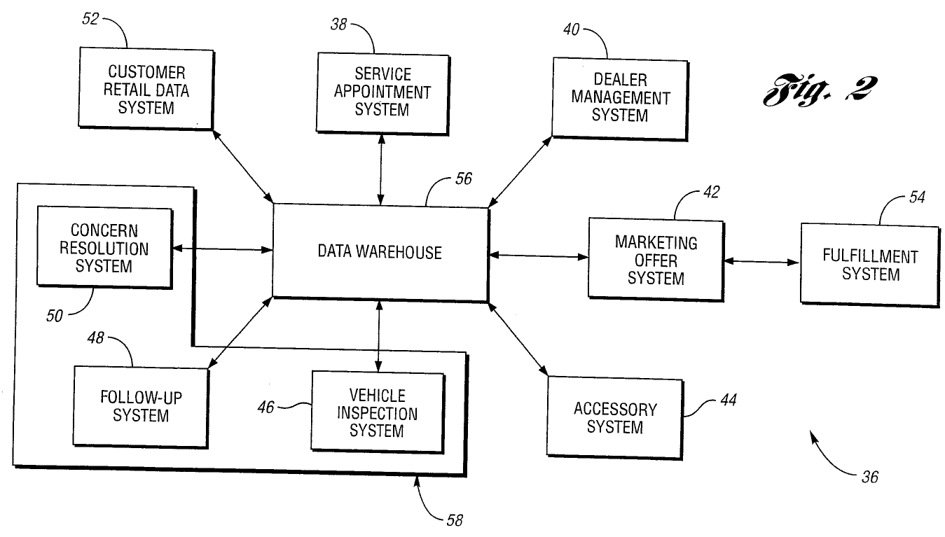

It is understood that overall system 8 is merely exemplary of the various embodiments for implementing the present invention. According to another embodiment of the present invention, greater than two computer systems can be in communication with the data warehouse. In one such system embodiment 36 as depicted in FIG. 2, at least seven computer systems are contemplated: service appointment system 38, dealer management system 40, marketing offer system 42, accessory system 44, vehicle inspection system 46, follow-up system 48, and concern resolution system 50. Each of these systems can receive, store, retrieve, and/or transmit data or information in the form of customer vehicle attributes. The customer vehicle attributes facilitate customer specific CRM activities since the attributes capture information at the customer-vehicle level. Non-limiting examples of customer vehicle attributes include basic core customer data, vehicle data, financial data, service history data, accessory purchase history data, demographic data, attitudinal data, loyalty data, extended service contract purchase history, opt-in/opt-out contacting information, preferred customer contact information, vehicle insurance information, and repair information.

Other systems, for example, customer retail data system 52 and fulfillment system 54, can be included as part of system embodiment 36, for reasons set forth below. It is understood that systems 38 through 54 can be interconnected directly or indirectly through a computer network, for example, a wide area network, a local area network, or a hybrid thereof. It is also understood that two or more of system 38 through 54 can be integrated to form an integrated system, for example integrated system 58, which is described in greater detail below.

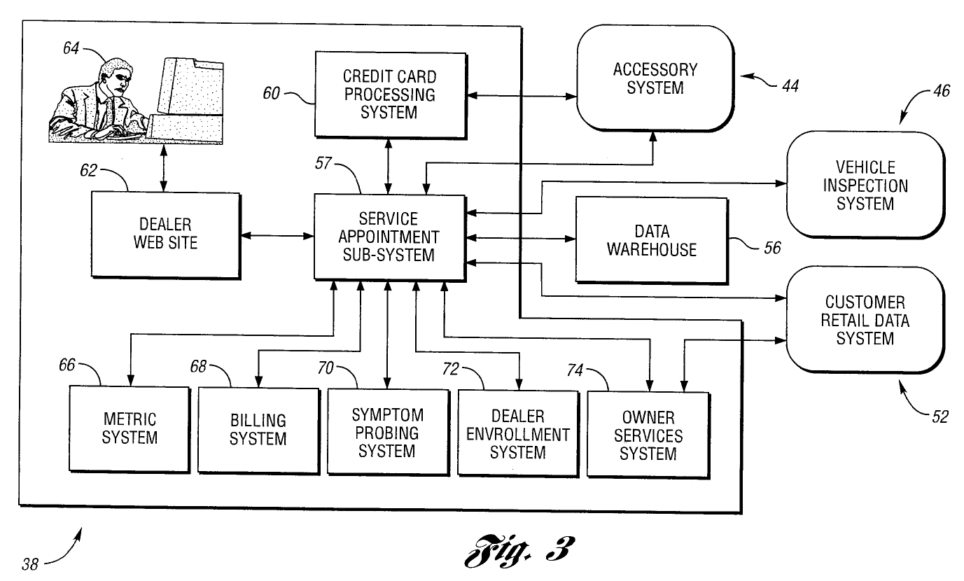

According to certain embodiments of the present invention, OEMs and dealers utilize service appointment system 38 to schedule service appointments for the servicing of a customer's vehicle. System 38 can also be utilized for scheduling recall appointments and maintenance appointments, and for checking the status of vehicle work. Turning to FIG. 3, a detailed example of service appointment system 38 is given. According to FIG. 3, system 38 is in direct communication with data warehouse 56, accessory system 44, vehicle inspection system 46, and customer retail data system 52. System 38 includes service appointment sub-system 57. In certain embodiments, service appointment sub-system 57 can be the system as disclosed in U.S. Pat. App. Publ. 2004/0059613 A1, published Mar. 25, 2004, and U.S. Pat. App. Publ. 2004/0059618 A1, published Mar. 25, 2004, and incorporated in their entirety herein by reference. As a general note, it should be understood that the communication lines depicted in the figures and described in the specification are not limited to strictly one-way or two-way communication, and can be either or both depending on certain implementations of the present invention.

Service appointment sub-system 57 is in electronic communication with various computer systems so that subsystem 57 can receive data from and/or transmit data to the various systems via communication lines. Sub-system 57 electronically communicates with data warehouse 56 to facilitate the update of service schedules and/or access parts and/or accessory inventories. Sub-system 57 electronically communicates with customer retail data system 52 to receive inspection data concerning customer vehicles. Sub-system 57 electronically communicates with vehicle inspection system 46 to receive and to send inspection data concerning customer vehicles. Sub-system 57 electronically communicates with accessory system 44 to receive accessory data.

Service appointment sub-system 57 is also in electronic communication with various computer sub-systems within the sphere of service appointment system 38. Sub-system 57 is in two-way electronic communication with credit card processing system 60 for processing customer credit card transactions. Credit card processing system 60 can also be in two-way electronic communication with accessory system 44. Sub-system 57 is in two-way communication with one or more dealer web sites 62 for providing a portal for one or more customers 64 to communicate with sub-system 57 via e-mail and web applets. Subsystem 57 electronically communicates with metrics system 66 to generate metrics reports relating to service appointments. Sub-system 57 electronically communicates with billing system 68 to generate billing reports, for example, monthly billing reports. Sub-system 57 is also in two-way electronic communication with symptom probing system 70, which includes functionality to ask customers symptom-probing questions concerning their vehicle. Sub-system 57 is in electronic communication with dealer enrollment system 72 for facilitating the enrollment of dealers in the service appointment sub-system 57. Subsystem 57 is in two-way electronic communication with owner services system 74 for facilitating various owner services. Owner services system 74 also receives repair order data from customer retail data system 52.

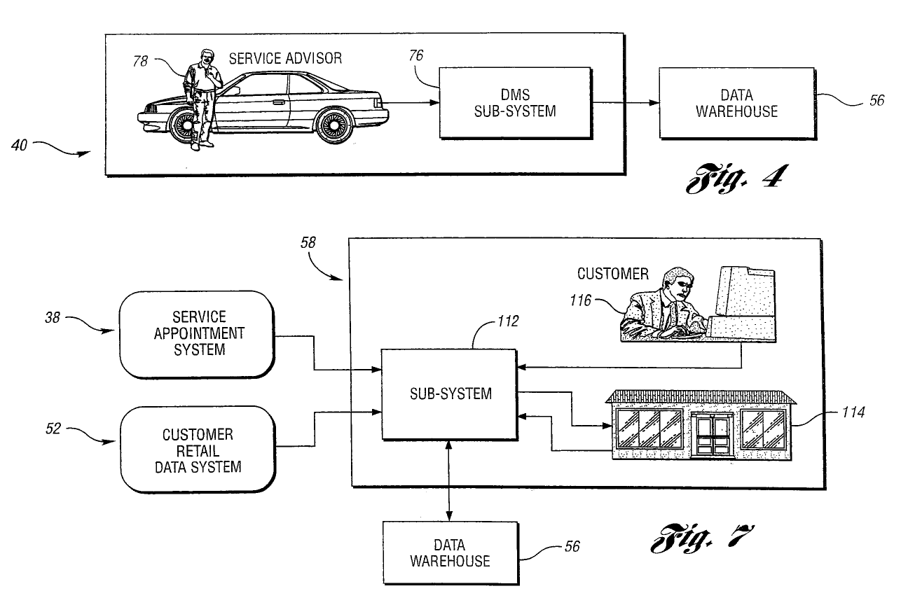

According to certain embodiments of the present invention, dealer management system 40 provides data to facilitate OEM sponsored maintenance services. Turning to FIG. 4, an example of a dealer management system is given. According to FIG. 4, system 40 is in direct electronic communication with data warehouse 56. System 40 includes dealer management sub-system 76, which is in two-way electronic communication with data warehouse 56 for transmitting and receiving nightly data concerning vehicle customer attributes. Sub-system 76 receives data from dealer service advisor 78.

In other embodiments of the present invention, the dealer management system includes data warehouse 56 and/or dealer management sub-system 76.

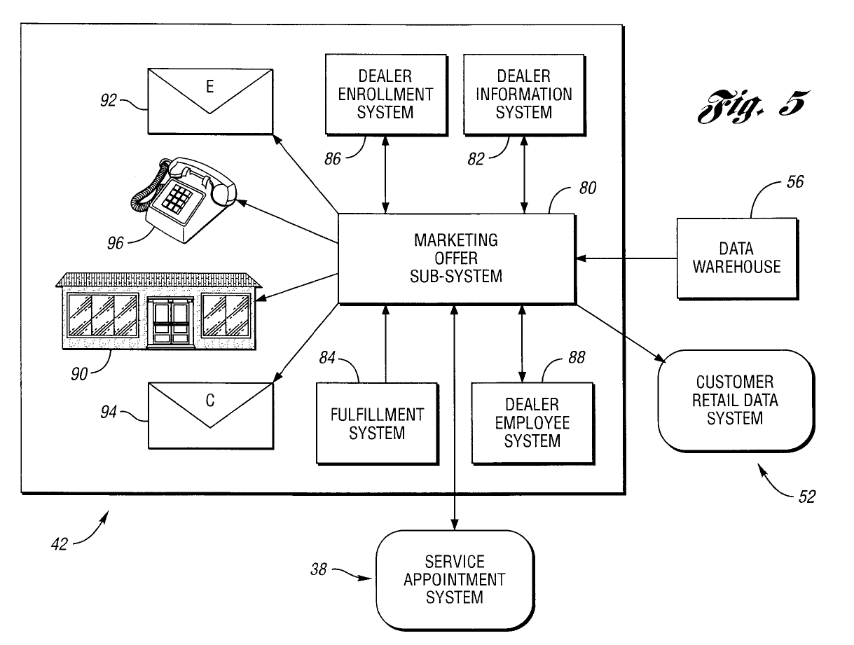

According to certain embodiments of the present invention, marketing offer system 42 is utilized by OEMs and dealers to facilitate the preparation and distribution of marketing offers, needed service offers, and/or maintenance offers. Turning to FIG. 5, a detailed example of a marketing offer system is given. According to FIG. 5, system 42 is in direct electronic communication with data warehouse 56, customer retail data system 52, and service appointment system 38.

System 42 includes marketing offer sub-system 80, which is in electronic communication with various computer systems so that sub-system 80 can receive data from and/or transmit data to the various systems via communication lines. Sub-system 80 electronically communicates with data warehouse 56 to facilitate receiving data stored in data warehouse 56. Sub-system 80 electronically communicates with customer retail data system 52 to facilitate extraction of data from system 52. A non-limiting example of extracted data is daily contact information. Subsystem 80 electronically communicates with service appointment system 38 to facilitate passing a marketing message to a service advisor and/or transmitting a marketing message to a customer via e-mail.

Marketing sub-system computer 80 is also in electronic communication with various computer sub-systems within the sphere of marketing offer system 42. Sub-system 80 is in electronic communication with dealer information system 82 for facilitating the receipt of dealer information. Sub-system 80 is in electronic communication with fulfillment system 84 for fulfilling marketing programs. Sub-system 80 is in electronic communication with dealer enrollment system 86 for facilitating the enrollment of dealers in the marketing offer sub-system. Sub-system 80 is in electronic communication with dealer employee system 88 for facilitating the receipt of dealer employee information.

Dealer management at dealer 90 can input customer vehicle attribute information into marketing offer sub-system 80. Sub-system 80 can generate marketing offers that can be delivered to customers through e-mail 92, conventional mail 94, or through phone contact 96.

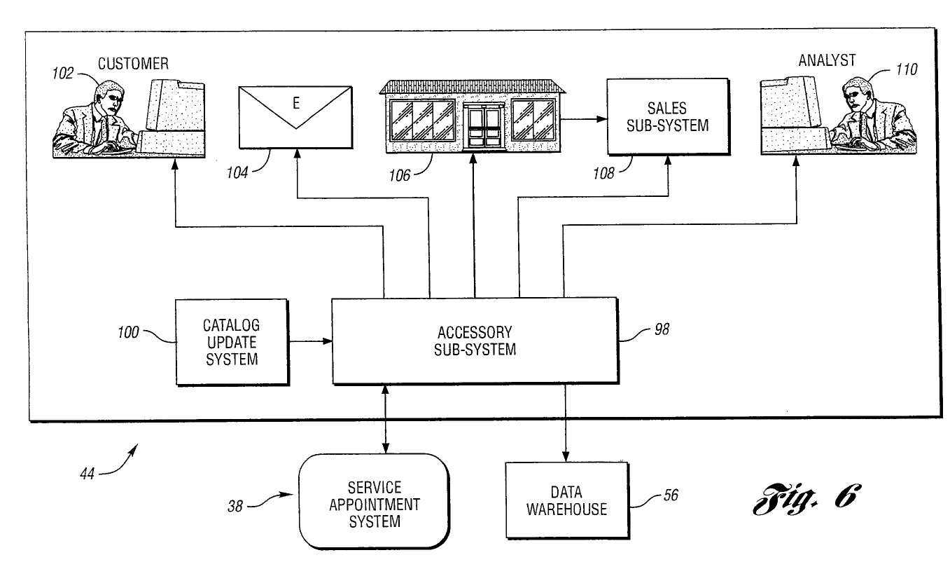

According to certain embodiments of the present invention, OEMs and dealers can utilize accessory system 44 to facilitate customer purchase and installation of vehicle accessories. Turning to FIG. 6, a detailed example of a service accessory system is given. According to FIG. 6, system 44 is in direct electronic communication with data warehouse 56 and service appointment system 38.

System 44 includes accessory sub-system 98, which is in electronic communication with various computer systems such that sub-system 98 can receive data from and/or transmit data to the various systems via communication lines. Sub-system 98 electronically communicates with data warehouse 56 to receive pricing and availability data. Sub-system 98 is in two-way electronic communication with service appointment system 38. Sub-system 98 is in electronic communication with catalog update system 100 to facilitate accessory catalog updates. Customer 102 can access a plurality of graphical user interfaces hosted by accessory sub-system 98 for facilitating customer personalization, and browsing and purchase of vehicle accessories. Accessory sub-system 98 can be configured to transmit e-mails 104 containing directed advertising materials based on customer personalization attributes. Dealership 106 is in electronic communication with accessory sub-system 98 to receive and transmit customer personalization data, which can be used by sales subsystem 108 to generate advertising materials regarding customer vehicle personalization and vehicle accessories. Vehicle personalization analyst 110 can access a plurality of graphical user interfaces hosted by accessory subsystem 98 for facilitating the generation of reports related to customer vehicle personalization.

According to a certain embodiment of the present invention, as depicted in FIG. 2, vehicle inspection system 46, follow-up system 48 and concern resolution system 50 can be combined within a single system 58. It is understood that each system 46, 48 and 50 can also be standalone. Vehicle inspection system 46 can be utilized to facilitate the dynamic inspection of customer vehicles. Follow-up system 48 can be utilized to facilitate dealer follow-up relating to work done on a customer's vehicle. Concern resolution system 50 can be utilized to resolve customer concern's relating to their vehicle or an experience at an OEM or dealership. An example of system 58 that integrates systems 46, 48 and 50 is disclosed in Application No. 10/770,145, filed Feb. 2, 2004, entitled “Computer-implemented Method And System For Collecting And Communicating Inspection Information For A Mechanism”, and is incorporated in its entirety herein by reference. Application Ser. No. 10/770,145 was published on ______ as U.S. patent application Ser. No. ______.

FIG. 7 depicts a block diagram of the architecture of a system that integrates vehicle inspection system 46, follow-up system 48 and concern resolution system 50 into integrated system 58 of FIG. 2. According to FIG. 7, integrated system 58 is in direct electronic communication with data warehouse 56, service appointment system 38, and customer retail data system 52. Integrated subsystem 112 electronically communicates with data warehouse 56 to facilitate update of inspection report cards, follow-up data, concern resolution data, and repair order updates. Sub-system 112 electronically communicates with customer retail data system 52 to receive closed repair order information. Sub-system 112 electronically communicates with service appointment system 38 to share service appointment information, inspection information, follow-up information and concern resolution information.

Sub-system 112 can also receive input from and transmit output to various sources, for example a dealer technician in dealer service bay 114 or customer 116. Service technician (not shown), working in dealer service bay 114 can input inspection information into a personal computer or hand held computer device, which transmits the data to sub-system 112. Sub-system 112 can also transmit an email that contains a customer satisfaction survey to customer 116, who completes the survey and transmits the completed survey to sub-system 112.

Customer retail data system 52 functions as a customer data repository. In certain embodiments, customer retail data system 52 can be integrated into data warehouse 56. Customer retail data system 52 can include a database (not shown) for storing the following non-limiting examples of customer vehicle attributes: vehicle sales information, OEM credit information, vehicle warranty information, used vehicle sales information, paid service information, extended service contract information, customer feedback and/or satisfaction survey information, dealer assignments, call center disposition, demographic information (for example, age, income, children) and lifestyle (for example, hobbies), purchase information concerning arrangements with third parties, campaign promotion history information, service reminder promotion information (for example, self-reported purchase intent and ownership of competitive makes), and other customer vehicle attributes either specifically or not specifically mentioned in this paper.

Having thus described one system embodiment of the present invention, one aspect of the present invention contemplates a computer-implemented method for implementing the above-described system. The method includes receiving one or more customer vehicle attributes from two or more computer systems selected from the group consisting of: a service appointment system, a dealer management system, a marketing offer system, an accessory system, a vehicle inspection system, follow-up system, and concern resolution system. The one or more customer vehicle attributes can be stored into a data warehouse and can be transmitted based on an electronic request. It is understood that the electronic request can originate from one of the above-identified computer systems or another computer system not specifically mentioned.

The one or more customer vehicle attributes are integrated across the two or more computer systems to facilitate management of an after vehicle sales delivery relationship between a customer and a service or product provider. This relationship can be managed on a VIN-specific level based on the integration of the one or more vehicle attributes. For instance, this integration is beneficial in contacting a customer to set an appointment for installation of an accessory, which was purchased after the vehicle sale. Another non-limiting integration examples include setting regular maintenance appointment based on the customer's purchase of a vehicle. Further, customer vehicle attributes pertaining to a customer's vehicle service file can be used to trigger reminder letters for service and/or maintenance.

While the best mode for carrying out the invention has been described in detail, those familiar with the art to which this invention relates will recognize various alternative designs and embodiments for practicing the invention as defined by the following claims.

1. A computer-implemented method for integrating data output from a relationship between a customer and a service or product provider, the method comprising:
receiving one or more customer vehicle attributes from two or more computer systems selected from the group consisting of: a service appointment system, a dealer management system, a marketing offer system, an accessory system, a vehicle inspection system, a follow-up system, and a concern resolution system;
storing the one or more customer vehicle attributes into a data warehouse; and
transmitting the one or more customer vehicle attributes stored in the data warehouse based upon an electronic request, wherein the one or more customer vehicle attributes are integrated across the two or more computer systems to facilitate management of a relationship between a customer and a service or product provider.

2. The method of claim 1 wherein the relationship is an after vehicle sales delivery relationship.

3. The method of claim 2 wherein the one or more customer vehicle attributes are selected from the group consisting of: basic core customer data, vehicle data, financial data, service history data, accessory purchase history data, demographic data, attitudinal data, and loyalty data.

4. The method of claim 3 further comprising tracking the one or more customer vehicle attributes.

5. The method of claim 1 wherein the service or product provider includes a dealer and/or an original equipment manufacturer (OEM).

6. The method of claim 5 further comprising communicating or broadcasting a portion of the one or more customer vehicle attributes to the customer.

7. The method of claim 6 wherein the communicating or broadcasting step is conducted by the OEM or the dealer.

8. The method of claim 6 wherein the communicating or broadcasting step is conducted by the OEM and the dealer.

9. The method of claim 3 further comprising generating a report based on the one or more customer vehicle attributes, wherein at least a portion of the report is communicated to the customer.

10. The method of claim 1 wherein the marketing offer computer system includes functionally for providing a plurality of fulfillment options.

11. The method of claim 6 further comprising formatting or packaging at least a portion of the one or more customer vehicle attributes prior to communicating or broadcasting the portion of the one or more customer vehicle attributes to the customer.

12. The method of claim 1 wherein the data warehouse includes a mainframe or ASP computer system.

13. The method of claim 1 wherein the service appointment system is capable of scheduling service and recall appointments and checking the status of an appointment.

14. The method of claim 1 wherein the marketing offer system is capable of transmitting service, maintenance offers, or product offers.

15. The method of claim 1 wherein the accessory system is capable of processing accessory purchases and installations.

16. The method of claim 6 wherein the portion of the one or more customer vehicle attributes is communicated through a telephone.

17. The method of claim 6 wherein the portion of the one or more customer vehicle attributes is communicated through the Internet.

18. The method of claim 17 wherein the portion of the one or more customer vehicle attributes is communicated through an e-mail via the Internet.

19. The method of claim 1 wherein the one or more customer vehicle attributes is used to facilitate marketing of one or more events.

20. The method of claim 1 further comprising dealerizing the one or more customer vehicle attributes.

21. The method of claim 1 further comprising deduplicating the one or more customer vehicle attributes.

22. The method of claim 1 further comprising cleansing the one or more customer vehicle attributes.

23. The method of claim 1 further comprising merging and purging the one or more customer vehicle attributes.

24. The method of claim 1 further comprising conducting a national change of address analysis on the one or more customer vehicle attributes.

25. The method of claim 1 further comprising conducting privacy “do not call” analysis on the one or more customer vehicle attributes.

26. A computer-implemented system for integrating data output from a relationship between a customer and a service or product provider, the system comprising:
two or more computer systems selected from the group consisting of: a service appointment system, a dealer management system, a marketing offer system, an accessory system, a vehicle inspection system, a follow-up system, and a concern resolution system, wherein the two or more computer systems are capable of storing and transmitting one or more customer vehicle attributes;
a data warehouse coupled to the two or more computer systems for storing the one or more customer vehicle attributes; and
a retrieval module coupled to the data warehouse for retrieving the one or more customer vehicle attributes stored in the data warehouse based upon an electronic request, wherein the one or more customer vehicle attributes are integrated across the two or more computer systems to facilitate management of a relationship between a customer and a service or product provider.

27. The system of claim 26 wherein the relationship is an after vehicle sales relationship.

28. A computer-implemented apparatus for integrating data output from a relationship between a customer and a service or product provider, the apparatus comprising:
means for receiving one or more customer vehicle attributes from two or more computer systems selected from the group consisting of: a service appointment system, a dealer management system, a marketing offer system, an accessory system, a vehicle inspection system, a follow-up system, and a concern resolution system;
means for storing the one or more customer vehicle attributes into a data warehouse; and
means for transmitting the one or more customer vehicle attributes stored in the data warehouse based upon an electronic request, wherein the one or more customer vehicle attributes are integrated across the two or more computer systems to facilitate management of a relationship between a customer and a service or product provider.

29. The apparatus of claim 28 wherein the relationship is an after vehicle sales relationship.
